(19) United States
(12) Patent Application Publication
(10) Pub. No.: US 2001/0002974 A1
(43) Pub. Date: Jun. 7, 2001

(54) TUNNEL DIGGING MACHINE

(75) Inventor: TONY DIMILLO, GORMLEY (CA)

Correspondence Address: DENNISON AND ASSOCIATES, SUITE 301, 133 RICHMOND STREET WEST, TORONTO, M5H2L7, CA

(73) Assignee: Tony Dimillo

(21) Appl. No.: 08/926,025

(22) Filed: Sep. 9, 1997

(30) Foreign Application Priority Data
Sep. 9, 1996 (CA) 2,185,057

(51) Int. Cl. B65G 47/16

(52) U.S. Cl. 414/565; 198/308.1

(57) ABSTRACT

A tunnel digging apparatus has an undercarriage pivotally attached to a moving means, the undercarriage being pivotable between a first moving position where the machine may be moved over a surface by operation of the moving means and a second operating position such that at least a portion of the undercarriage is in contact with the surface. The machine in the operating position is supported by at least a portion of the moving means and the portion of the undercarriage in contact with the surface.

### FIELD OF THE INVENTION

The present invention relates to tunnel digging machines and particularly tunnel digging machines having an increased productivity.

### BACKGROUND OF THE INVENTION

Various apparatus have been used for removing earth in a tunneling operation including the use of remotely controlled boring apparatus which are basically augers, to the use of digging machines such as back hoe type equipment. A number of specialized tunnel digging machines have been developed which have improved the efficiency of tunneling operations. One such digging machine is shown in Canadian Patent 1,264,701 owned by the present applicant. The digging machine of Canadian patent 1,264,701 was provided with a stationary bed supporting a conveyor and a raised telescopic boom mounted on a tiltable table having a wide degree of movement about three axes, i.e. up and down, side to side and rotatable about its longitudinal axis. The digging machine of the patent provided increased flexibility and production in the digging of tunnels. The digging machine of the patent was operated by moving it into position by using a wheel arrangement placed under the stationary bed. Once the machine was in position, the wheel arrangement was removed and the stationary bed secured to rails provided in the tunnel or to the tunnel walls itself. When it was necessary to move the machine as the tunnel progressed, the wheel arrangement was moved into position below the stationary bed, the bed lowered to the wheel arrangement, moved forward and then the wheel arrangement removed once again. These operations require a significant amount of time which reduce the tunneling efficiency.

### SUMMARY OF THE INVENTION

The present invention provides a tunnel digging machine having an undercarriage pivotally attached to a moving means, the undercarriage being pivotable between a first moving position where the machine may be moved over a surface by operation of the moving means and a second operating position such that at least a portion of the undercarriage is in contact with the surface whereby the machine is supported by at least a portion of the moving means and the portion of the undercarriage in contact with the surface.

In an aspect of the invention there is provided a tunnel digging machine having an undercarriage supporting a telescopic boom. The boom being mounted on a boom support table which is rotatable on the undercarriage. The boom is pivotable, up and down, on the boom support table and is able to rotate about its longitudinal axis thereby providing the telescopic boom with a wide degree of movement about three axis.

### BRIEF DESCRIPTION OF THE DRAWINGS

Preferred embodiments of the present invention are shown in the drawings wherein:

FIG. 1 is a perspective view of the tunnel digging machine;

FIG. 2 is a side elevation view of a tunnel digging machine in a moving position;

FIG. 3 is a side elevation view of the tunnel digging machine in a first operating position; and

FIG. 4 is a side elevation view of the tunnel digging machine in a second operational position.

### DETAILED DESCRIPTION OF THE PREFERRED EMBODIMENTS

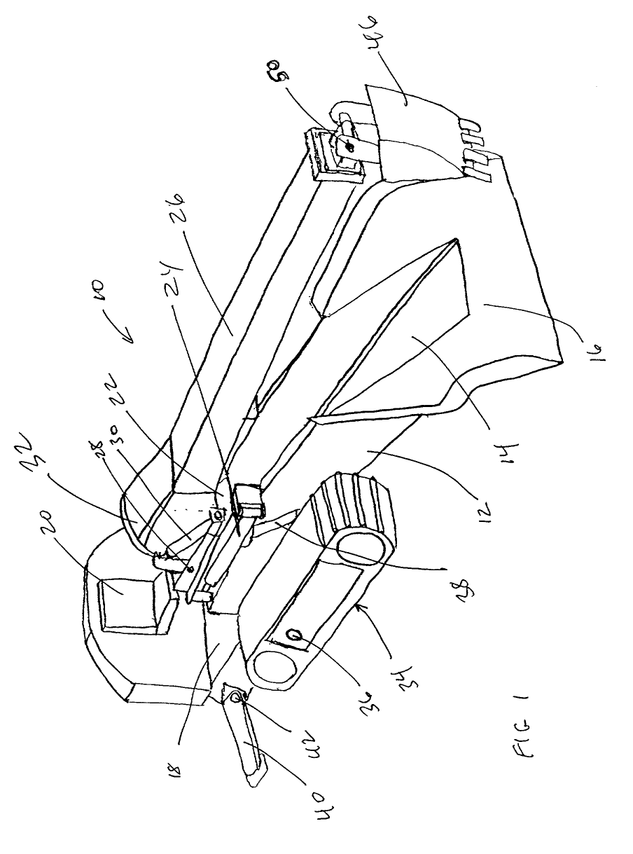

A preferred embodiment of a tunnel digging machine of the present invention generally shown as 10 in FIG. 1 of the drawings includes an undercarriage 12 which supports a conveyor 14 running the length of the undercarriage for transporting the debris of the tunnel digging operation rearwardly through the machine 10. The undercarriage 12 includes a downwardly sloping shovel 16 at the front end for moving the debris from the tunnel onto the conveyor 14. The shovel 16 is preferably enlarged at the end with the sides extending outwardly from the side of the undercarriage to the end of the shovel 16. This provides the shovel 16 with a larger area for collecting of debris and increases the loading capacity of the machine 10. At the rear of the undercarriage 12 there is an operator's platform 18 which may include a seat 20 for the operator. To protect the operator during the digging operation, the tunnel digging machine 10 may be provided with a suitable shield in a conventional manner (not shown in the drawings).

A boom support table 22 is movably attached to the top of the undercarriage 12. The boom support table 22 is supported on the undercarriage 12 by means of rotatable connection which allows the boom support table 22 to rotate. The rotation of the boom support table 22 is achieved by the action of hydraulic cylinders 24 which are located on either side of the tunnel digging machine 10. One end of the hydraulic cylinder 24 is attached to the undercarriage 12 while the second end is attached to the boom support table 22. Actuation of the hydraulic cylinders 24 moves the boom support table 22 from side to side in a horizontal plane to allow the boom 26 attached to the boom support table 22 to reach the side walls of the tunnel during the digging operation. The boom 26 is preferrably a telescopic boom as described in Canadian Patent 1,264,701.

The boom support table 22 supports the boom 26 in a manner to permit the boom 26 to move up and down as well as to permit the boom 26 to rotate along its longitudinal axis. Boom 26 at either side is attached to the boom support table 22 by a journal connection 28. A hydraulic cylinder 30 having one end attached to the boom 26 and its other end attached to the boom support table 22 also connects the boom 26 to the boom support table 22. Actuation of the hydraulic cylinders 30 rotates the boom 26 about the journal connection 28 moving the boom 26 up and down. The boom 26 is also provided with a cylindrical mount 32 in the manner taught by Canadian patent 1,264,701, to permit the boom 26 to rotate about its longitudinal axis. The boom 26 at the end is provided with a drive gear which cooperates with an actuating gear controlled by a hydraulic motor.

A driving or moving means is provided to support the undercarriage 12 of the tunnel digging machine 10 and permit the machine 10 to be easily moved into position to commence digging operations. In the figures the moving means is shown as crawling tracks 34 mounted to the undercarriage on either side however, other moving means such as rubber tires are possible. The crawling track 34 is mounted to the undercarriage 12 by means of an axle 36 extending across the undercarriage. The crawling track 34 is attached to the end of the axle 36 near one end of the crawling track 34. The other end of the crawling track 34 is attached to the undercarriage 12 by a hydraulic cylinder 38 to enable the undercarriage 12 to be raised and lowered to move between the moving position and the operating position by operation of the hydraulic cylinder 38.

The undercarriage 12 may also be provided with extendible support legs 40 at the rear to provide for a further support for the undercarriage 12 when in an operating position as will be explained further below. The extendible support legs 40 are attached to the undercarriage 12 by journals 42 which permit the extendible legs 40 to pivot vertically and from side to side. The extendible legs 40 are moved by means of hydraulic cylinders connecting the legs to the undercarriage 12.

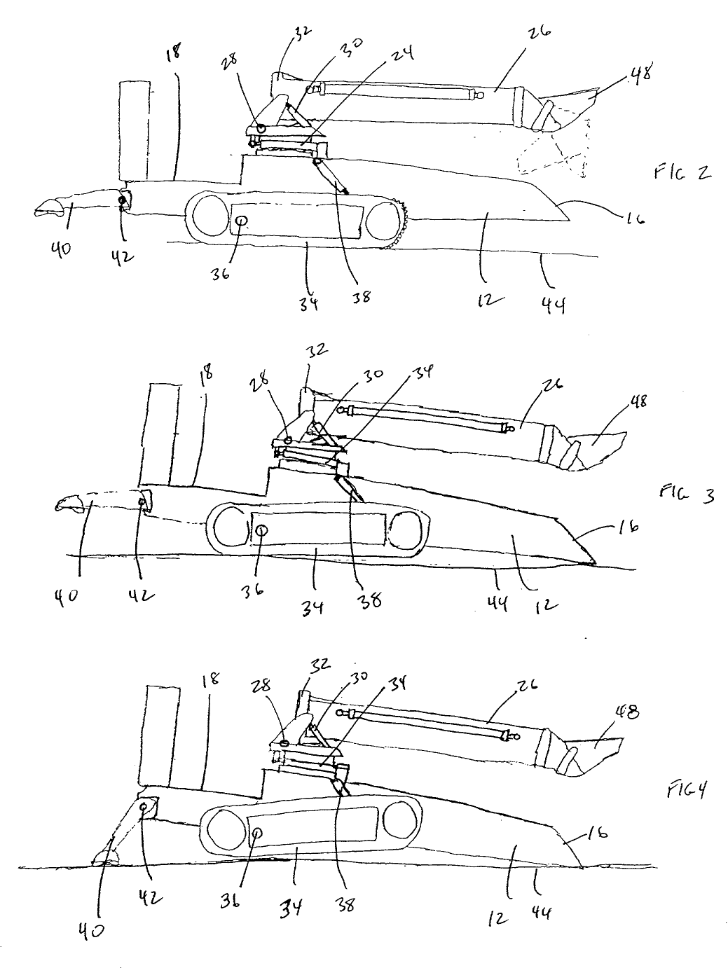

The operation of the tunnel digging machine 10 of the present invention is illustrated in FIGS. 2 through 4. The tunnel digging machine 10 is moved into position to commence digging of the tunnel by using the crawling tracks 34 or other moving means to drive or move the machine 10 into position. As shown in FIG. 3, once the machine 10 is in position, typically at the tunnel face, the hydraulic cylinders 38 connecting the crawling tracks 34 to the undercarriage 12 are operated to lower the front of the undercarriage 12 by allowing the undercarriage 12 to pivot about the axle 36 until it contacts the surface. The hydraulic cylinders 38 continue to operate to raise the front of the crawling tracks 34 off the surface 44. In this way, the machine 10 is in an operating position, supported by shovel 16 at the front of the undercarriage 12 and the rear of the moving means 34 in contact with the surface 44.

For some operations such as mucking operations, the amount of support provided to the machine 10 by the position shown in FIG. 3 may be sufficient. For other operations, it may be desirable to provide a broader base of support for the machine 10. This is accomplished by the use of the extendible support legs at the rear of the undercarriage 12. The extendible legs 40 pivot downwardly by operation of the hydraulic cylinder until they contact the surface 44 and support the rear of the undercarriage 12. If desirable, the extendible legs 40 may be continued to be moved downwardly until the undercarriage 12 is raised to a level to raise the crawling tracks 34 totally clear of the surface 44 as shown in FIG. 4. In this operating position, the tunnel digging machine 10 is supported on the surface 44 by the contact of the shovel 16 at the front of the undercarriage 12 and the extendible support legs 40. Depending upon the width of the tunnel being dug, the extendible support legs 40 may be pivoted outwardly form the undercarriage 12 before being pivoted downwardly to provide a broader base of support to the machine.

When it is desired to move the machine 10 such as to moving the machine 10 forward as the tunnel digging operation proceeds, the above operations are reversed. The extendible legs 40, if they have been used, are first lifted upwardly and inwardly to return the rear of the crawling tracks 34 into contact with the surface 44. The front of the undercarriage 12 is raised until it is clear of the surface and the crawling tracks 34 are fully in contact with the surface 44. With the machine 10 in the moving position, it may be moved forward to the new digging location and then placed in the suitable operating position.

As has been shown in the figures, a number of different digging implements may be used with the machine of the present invention. Such digging implements include excavation buckets 46 as shown in FIG. 1, mucking buckets 48 as shown in FIG. 2, pneumatic or hydraulic rock drills, hammers, etc. The digging implements 46, 48, etc. are attached to the end of the boom 26 in a manner to permit quick interchangeability such that the implement 46, 48, may be exchanged in a short period of time, typically on the order of about 15 minutes. This is accomplished in one embodiment by attaching the implement 46, 48, to the end of the boom 26 by shafts having a threaded end and securing the shaft by a suitable bolt 50.

As is also shown in the figures, the digging implement 46, 48 is attached to the end of the boom 26 in a manner to permit the implement 46, 48 to be pivoted independent of the movement of the boom 26. This is accomplished through the use of suitably placed hydraulic cylinders to connect the digging implement 46, 48, either directly or indirectly to the end of the boom. The digging implement may be attached to a mounting plate which is in turn attached to the end of the boom by a pivotable connection such as a journal and by the hydraulic cylinder. This arrangement reduces the switch over time for changing the tools as the hydraulic cylinders remain permanently attached to the mounting plate and do not have to be disconnected and reconnected for each change of the digging implement 46, 48.

The tunnel digging machine of the present invention provides a multi-purpose and expandable construction and mining machine that improves the efficiency of tunneling and mining operations. The provision of the moving means enables the machine to be easily moved as the tunneling and mining operations proceed, increasing the productivity.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are as follows:

1. A tunnel digging machine comprising an undercarriage pivotally attached to a moving means, the undercarriage being pivotable between a first moving position where the machine may be moved over a surface by operation of the moving means and a second operating position such that at least a portion of the undercarriage is in contact with a surface whereby the machine is supported by at least a portion of the moving means and the portion of the undercarriage in contact with a surface.

2. A tunnel digging machine as claimed in claim 1 wherein the front of the undercarriage pivots downwardly to contact a surface and support the machine.

3. A tunnel digging machine as claimed in claim 2 wherein the undercarriage is further provided at the back with extendible support legs to provide support for the machine when extended to contact a surface.

4. A tunnel digging machine as claimed in claim 3 wherein the extendible support legs are capable of raising the undercarriage to raise the attached moving means from contact with a surface.

5. A tunnel digging machine as claimed in claim 4 wherein the moving means is a crawling track mounted on either side of the undercarriage.

6. A tunnel digging machine as claimed in claim 5 wherein a telescopic boom is rotatably mounted to the undercarriage to permit rotation of the boom in a horizontal plane, the boom further being movable in a vertical plane and rotatable about a longitudinal axis of the boom.
